(19) United States
(12) Patent Application Publication
(10) Pub. No.: US 2004/0258810 A1
(43) Pub. Date: Dec. 23, 2004

(54) Method of producing salted cod roe

(76) Inventor: Matsuda Shinichi, Shiranuka-gun (JP)

Correspondence Address: MCGLEW & TUTTLE, PC, 1 SCARBOROUGH STATION PLAZA, SCARBOROUGH, NY, 10510-0827, US

(21) Appl. No.: 10/624,654

(22) Filed: Jul. 22, 2003

(30) Foreign Application Priority Data
Jun. 21, 2003 (JP) 2003-171721

(51) Int. Cl. A23L 1/31

(52) U.S. Cl. 426/281

(57) ABSTRACT

Provided is a method of producing salted cod roe including pickling the roe with a seasoning solution by injecting the seasoning solution into the roe. In the method, frozen roe or fresh roe is washed with saline solution and then the seasoning solution is injected into the roe followed by standing for a predetermined time so that the seasoning solution can migrate into the roe to perform of pickling the roe with the seasoning solution. The method can produce salted roe of a high quality without causing uneven pickling and uneven coloring, achieve uniform migration of the seasoning solution therein in a short time, and maintain the most tasty state specific to salted cod roe. As a result, just-produced, fresh salted cod roe that can be eaten in the most tasty state is produced.

### BACKGROUND OF THE INVENTION

1. Field of the Invention

The present invention relates to a method of producing salted cod roe, in particular to a method that allows seasoning solution to uniformly migrate into the roe in a short time to produce salted cod roes of uniform quality with a high seasoning effect in a short time.

2. Description of the Related Art

Salted cod roe is ovary of Alaska Pollack, so-called cod roe, (hereinafter also referred to as roe) immersed in a seasoning solution (salted).

Conventional method of producing salted cod roe is outlined as follows. First, frozen cod roe is thawed and the thawed roe is washed. The washing is performed with approximately 3% saline solution. After the washing, the cod roe is lightly drained and weighed and then charged in a pickling cask (rotary cask) and immersed in seasoning solution. After completion of pickling for a predetermined period of time (about 1 day to 3 days), the cod roe is taken out of the cask and charged in a drain vessel where removal of the seasoning solution (draining) and maturation (approximately 24 hours) are performed to produce salted cod roe. Thereafter, the salted cod roe is frozen, stored and then shipped. Usually, as soon as the draining and maturation are completed, selection/removal of foreign matter and weighing are performed and the salted cod roe is packaged, frozen, stored and then shipped.

Conventionally, pickling of roe has been performed by using a rotary cask as a pickling cask and rotating the cask a half-turn for every predetermined time. This has been intended to help the seasoning solution and colorants to migrate into the roe while preventing occurrence of uneven pickling and uneven coloring, thereby enabling uniform pickling. However, since roe is covered with an ovarian membrane, it takes time for the seasoning solution or the like to migrate therein. Also, the rate of migration of the seasoning solution may vary depending on the kind and concentration of the seasoning solution as well as the quality of the roe. Therefore, the conventional production method has had a problem in obtaining roe having acceptable quality in which seasoning solution and the like are uniformly migrated. Accordingly, a method of producing salted cod roe in which vibration is imparted to roe during the process of pickling the roe with a seasoning solution has been proposed (cf., for example, JP6-38718A; claims, page 2, left column, paragraph number 0005).

According to the above-mentioned method of producing salted cod roe, salted cod roe can be produced in a shorter time compared with the conventional method. However, the method still has the following problems.

Even when salting (pickling with a seasoning solution) is performed while imparting vibration to the roe, salting for only a short time results in incomplete salting so that a certain length of vibration time is necessary. This inevitably causes deterioration in quality of roe, such as deformation of roe, destruction of roe and softening of roe. Further, although an improvement over the conventional method is achieved, it becomes necessary to set a longer time for salting (vibrating) for all the products to have a satisfactory quality. This is because, in spite of vibration being imparted to the cod roe, there occurs a fluctuation in time in which a seasoning solution is migrated into the inside of the cod roe depending on the size and degree of maturity of the cod roe, thickness of ovarian membrane, and so forth. However if the salting time is set longer, then the problem as described above arises again. On the contrary, a shorter salting time results in uneven salting and uneven coloring, thereby leading to a difference in the quality of cod roes.

However, other conventional methods of producing salted cod roe in which no vibration is imparted upon salting have further problems as described below.

Since the migration of seasoning solution into the inside of cod roe fluctuates depending on the size and degree of maturity of cod roe as well as the thickness of ovarian membrane, a long-time pickling is necessary, so that the production of cod roe takes a long time.

Although it is effective to elevate the temperature of pickling solution in order to improve the migration of seasoning solution into roe, it takes a long time for the seasoning solution to be uniformly migrated into the inside of the roe, and the risk of proliferation of microorganisms arises.

In the case where pickling time is prolonged or the amount of seasoning solution is increased in order to improve the migration of the seasoning solution, the roe becomes too soft and the quality thereof is decreased. To prevent this, it becomes necessary to increase the amount of the seasoning solution to be added and increase the Brix scale of the seasoning solution.

When the migration of the seasoning solution or the like into the inside of the roe is uneven, there occur uneven pigmenting or coloring, thereby decreasing the quality thereof.

### SUMMARY OF THE INVENTION

Under the circumstances, the present invention has been made and an object of the present invention is to provide a method of producing salted cod roe that allows seasoning solution to uniformly migrate into roe in a short time and produces salted cod roes of uniform quality with a high seasoning effect in a short time.

According to a first aspect of the present invention, there is provided a method of producing cod roe, including pickling the roe with a seasoning solution by injecting the seasoning solution into the roe.

Since the roe is pickled with a seasoning solution by injecting the solution into the roe, there can be produced salted cod roe of high quality in which the seasoning solution is uniformly migrated in short time and no pickling unevenness and coloring unevenness are caused.

Note that “pickling cod roe with a seasoning solution by injecting the seasoning solution into the roe” as used herein means include both a case where pickling is performed only by injecting seasoning solution into cod roe and a case where cod roe into which seasoning solution is injected is immersed in a separately provided seasoning solution. The roe used in the present invention includes ovary of Alaska Pollack (so-called Walleye Pollack roe) and ovary of cod (so-called cod roe) and salted cod roe includes salted “Walleye Pollack roe” and salted “cod roe”.

Further, according to a second aspect of the present invention, there is provided a method of producing salted cod roe, including pickling with a seasoning solution by injecting the seasoning solution into the roe and then freezing the roe.

By freezing the salted cod roe in addition to pickling of the roe with a seasoning solution, which increases the shelf life of salted cod roe, deterioration of the quality of salted cod roe can be prevented, further achieving improvement in the shelf life of the product.

Further, according to a third aspect of the present invention, there is provided a method of producing salted cod roe, including washing thawed or fresh cod roe with saline solution and then injecting a seasoning solution into the cod roe.

Note that the seasoning solution used in the present invention is not particularly limited and any conventional seasoning solution can be used. Generally, the seasoning solution is prepared by adding and mixing salts, colorants, stringents, seasonings and so forth in water. Further, in the present invention, the method of pickling with a seasoning solution can be performed by any conventional method.

### BRIEF DESCRIPTION OF THE DFRESHINGS

FIG. 1 is a front view illustrating the principle of the present invention;

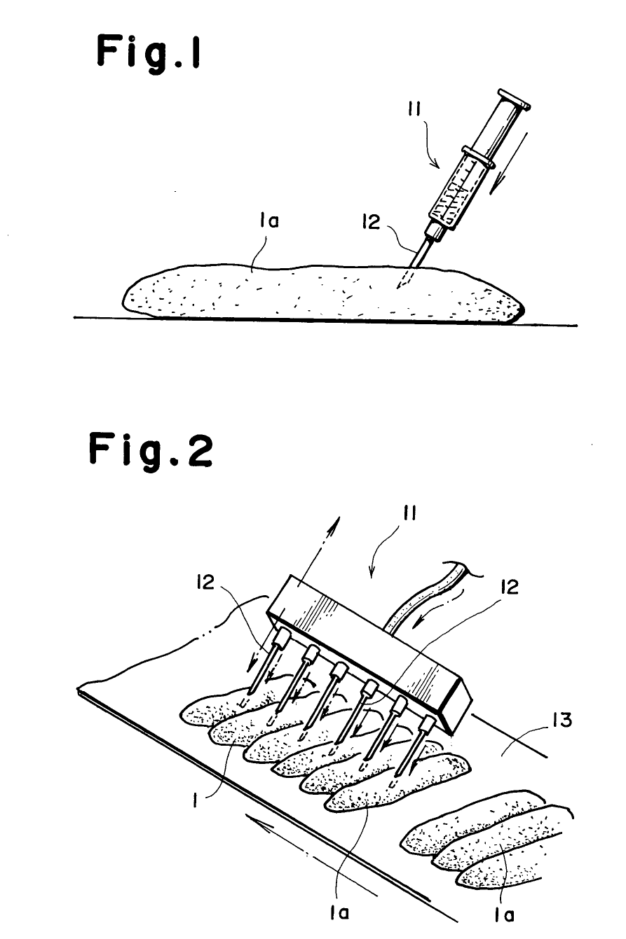

FIG. 2 is a perspective view illustrating a method of producing salted cod roe according to one embodiment of the present invention; and

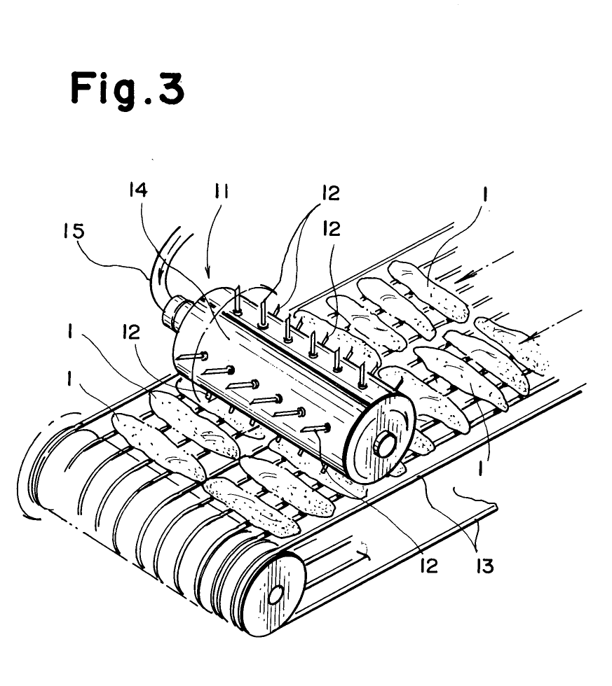

FIG. 3 is a perspective view illustrating a method of producing salted cod roe according to another embodiment of the present invention.

### DESCRIPTION OF PREFERRED EMBODIMETNS

Hereinafter, the method of producing salted cod roe according one embodiment of the present invention will be described in detail with reference to the attached drawings, in which FIG. 1 is a front view illustrating the principle of the present invention and FIG. 2 is a perspective view illustrating a method of producing salted cod roe according to one embodiment of the present invention.

In the method of producing salted cod roe according to the present invention, thawed roe or fresh roe is washed with saline solution and then seasoning solution is injected into the roe and left to stand for a predetermined time to perform pickling of the roe with the seasoning solution. On this occasion, the pickling of the roe with seasoning solution includes both a case where pickling is performed only by injecting seasoning solution into cod roe and a case where cod roe into which seasoning solution is injected is immersed in a separately provided seasoning solution. Usually, the latter method is adopted. The seasoning solution is injected into roe 1 by using an injector 11 having a needle 12 that pricks the roe 1 as shown in FIG. 1. It is preferable that the needle 12 is as thin as possible and as sharp as possible in the tip thereof so that no damage is caused to the ovarian membrane that would decrease the quality of the roe. It is inefficient in terms of productivity to perform injection with one injector 11 for each roe as shown in FIG. 1 and such method is practically unsuitable. In practice, for example, a plurality of roes 1 mounted on and conveyed by a belt conveyer 13 are simultaneously injected by using an injector 11′ having a plurality of needles 12 as shown in FIG. 2.

Further, FIG. 3 is a perspective view illustrating a method of producing salted cod roe according to another embodiment of the present invention. The injector 11″ in this embodiment has a cylindrical rotary liquid injection cylinder 14, around which a plurality of needles are provided projecting radially at predetermined intervals. To the liquid injection cylinder 14 is connected a liquid supply pipe 15. The injector 11″ automatically injects seasoning solution into a plurality of roes 1 mounted on and conveyed by the belt conveyer 13 through needles 12 while rotating the liquid injection cylinder 14. Also, according to the this embodiment, the seasoning solution is automatically injected into the roes through the needles 12 while the liquid injection cylinder 14 is supplied with the seasoning solution through the liquid supply pipe 15.

Hereinafter, one example of the method of producing salted cod roe according to the present invention will be described in the order of processing steps.

(1) Thawing

Usually roes are frozen. Therefore, they are thawed before they can be processed. In the case of fresh roes, the thawing is unnecessary.

(2) Washing

Then, the thawed roes or fresh roes are washed. The washing is performed with a saline solution having a concentration of 3%. A concentration of 3% is a standard value and may be somewhat decreased or increased.

(3) Injection of Seasoning Solution

To the roes washed as described above is injected seasoning solution. The seasoning solution can be injected by a conventional method. For example, the means shown in FIGS. 2 and 3 may be used. The seasoning solution to be injected is not particularly limited and any conventional seasoning solution may be adopted. The seasoning solution mentioned here is usually prepared by adding and mixing salts, colorants, stringents, seasonings, and the like in water. Conventional seasoning solution having any formulations may be used.

(4) Weighing

Then, the amount of roes to be charged in a pickling cask is weighed. The addition amount of the seasoning solution (pickling solution) to the amount (weight) of the roe is substantially fixed. Therefore, it is necessary to weigh the roes before they can be charged in the pickling cask. The amount of the seasoning solution to be charged in the pickling cask is then determined depending on the amount of the roes. Weighing is also necessary for determining the amount of the roes to be charged in the pickling cask since the size (volume) of the pickling cask is fixed. Once the size (volume) of the pickling cask is determined, the amount of the roes to be charged and the amount of the seasoning solution (pickling solution) to be charged are also determined. As an example of the addition amount of the seasoning solution to the amount of the roe, there are given such values as about 6 liters of seasoning solution to 15 kg of roes. In practice, 15 kg of roes are charged into the injector 11 and the roes 1 into which seasoning solution has been injected by the injector 11 are received in a pickling cask. The total weight of the cask and the contents is weighed, adjusting the addition amount of the seasoning solution so that the total weight becomes a predetermined weight.

(5) Pickling with Seasoning Solution

A predetermined amount of roes and a predetermined amount of seasoning solution are charged in a pickling cask to perform pickling. Since the seasoning solution is injected into the roes 1, the migration of the seasoning solution into the roes 1 is finished in a short time. Therefore, it is sufficient to perform the pickling with seasoning solution here for about 16 hours or less.

Note that the pickling cask is usually a rotary cask and initially the pickling is performed by rotating it a half-turn for every predetermined time. The number of times of the half-turn rotation for every predetermined time may be reduced. For example, it may be performed in a frequency of one third or less of the conventional frequency. For example,

a. First, two times of a half-turn rotation for every 5 minutes (10 minutes),

b. Then, two times of a half-turn rotation for every 15 minutes (30 minutes),

c. Then, five times of a half-turn rotation for every 1 hour (5 hours), and

d. Thereafter, leaving (standing still) for 10 hours.

Here, the seasoning solution to be used is not particularly limited and any conventional seasoning solution may be used. The solution may be same as that used in injection into the roes or a different solution. It is preferable that seasoning solution prepared by blending additives (salts, colorants, stringents, seasonings and so forth) in water is charged into the pickling cask (rotary cask) since the additives are dissolved uniformly and the seasoning solution can effectively act. However, the water containing a colorant and other additives may be separately charged into the pickling cask. Even if they are charged separately, intermittent half-turn rotations (each 180°) of the rotary cask produces a well stirred and mixed seasoning solution in the rotary cask.

The pickling of the roes in the rotary cask as well as the injection of the seasoning solution into the roes gives rise to salted cod roes of satisfactory quality free of uneven pickling and uneven coloring. In addition, the pickling with the seasoning solution is performed in half the time required by the conventional method.

Note that the present invention is not limited to the pickling by adopting a rotary cask, pickling time, number of rotations and time of intermittent half-turn, additives, seasoning solution and so forth as described above. They are merely examples.

(6) Draining

Next, when the above-mentioned pickling with the seasoning solution is completed, the roes are taken out of the pickling cask (rotary cask) and draining is performed by mounting the roes on a grating for draining, a strainer or the like.

Conventionally, the draining has been performed by leaving (incubating) the roes for at least 24 hours in order to perform maturation simultaneously. In the present invention, since the seasoning solution is injected into the inside of the roes, the draining/maturation does not have to be performed for a long time but need be performed only for a short time, for example, 12 hours or less. The draining needs be performed to such an extent that at least selection/removal of foreign matter in the subsequent step can be performed.

(7) Selection/Removal of Foreign Matter

Then, selection/removal of foreign matter in the roes is performed. This is performed in order to trim the size and remove defects to achieve uniform quality of the roes or check if any foreign matter is contained and perform removal treatment in some cases. The selection/removal of foreign matter may be performed before the injection of the seasoning solution.

(8) Weighing

Here, the weighing refers to weighing cod roes to a predetermined amount suitable for packaging. Cod roes are packaged in containers by a predetermined amount to be stored and shipped. That is, the salted cod roes thus produced are packaged, frozen, stored, and then shipped.

Note that the above-mentioned embodiments are not intended to limit the present invention thereto but various modifications may be made to the present invention without departing from the spirit and scope of the invention as defined by the appended claims.

As described above in detail, according to the method of producing salted cod roe of the present invention, the following effects can be obtained.

(1) Since a seasoning solution is directly injected into the inside of the roe, the seasoning solution can migrate therein in a short time, so that salted cod roe of a high quality can be produced without causing uneven pickling and uneven coloring in a short time.

(2) Since a seasoning solution is directly injected into the inside of the roe, the expected effects can be obtained at a low temperature and salted cod roe can be produced in a short time. Accordingly, the danger of proliferation of microorganisms can be prevented.

(4) Since a seasoning solution is directly injected into the inside of the roe, the seasoning solution acts uniformly and effectively on the roe so that the addition amounts of the additives including salts and the seasoning solution can be minimized.

(5) Since seasoning solution is directly injected into the inside of the roe, uniform seasoning is always possible regardless of the size and degree of maturity of the roe as well as the thickness of the ovarian membrane. Further, uniform pigmentation and coloring can be performed. Furthermore, since seasoning solution is directly injected into the inside of the roe, expansion of the roe can be made uniform so that fluctuation in expansion can be improved.

(6) Since the present invention requires less time for draining/maturation after completion of pickling with a seasoning solution, a further decrease in production time can be achieved.

1. A method of producing salted cod roe, comprising pickling the roe with a seasoning solution by injecting the seasoning solution into the roe.

2. A method for producing salted cod roe, comprising pickling the roe with a seasoning solution by injecting the seasoning solution into the roe and then freezing the roe.

3. A method of producing salted cod roe according to claim 1, further comprising washing thawed or fresh roe with a saline solution and then injecting the seasoning solution into the roe.

4. A method of producing salted cod roe according to claim 2, further comprising washing thawed or fresh roe with a saline solution and then injecting the seasoning solution into the roe.
